(19) United States
(12) Patent Application Publication
(10) Pub. No.: US 2012/0062504 A1
(43) Pub. Date: Mar. 15, 2012

(54) TOUCH SCREEN AND METHOD OF MANUFACTURING THE SAME

(75) Inventors: Sang Hwa Kim, Gyunggi-do (KR); Jong Young Lee, Gyunggi-do (KR)

(73) Assignee: SAMSUNG ELECTRO-MECHANICS CO., LTD., Gyunggi-do (KR)

(21) Appl. No.: 12/948,617

(22) Filed: Nov. 17, 2010

(30) Foreign Application Priority Data
Sep. 10, 2010 (KR) 1020100089006

(51) Int. Cl. G06F 3/044; H01J 9/00

(52) U.S. Cl. 345/174; 445/24

(57) ABSTRACT

Disclosed herein are a touch screen and a method of manufacturing the same. The touch screen includes a transparent substrate, a transparent electrode formed on the transparent substrate and adopted for sensing a change in capacitance when a touch input is performed, an adhesive layer formed on the transparent substrate in which the transparent electrode is formed, a window plate bonded with the transparent substrate by the adhesive layer, and a circular polarization-coating layer coated on the window plate and adopted for transmitting light in one direction, whereby a circular polarization coating layer may block reflected light from an inside of the touch screen, thereby improving visibility of the touch screen.

### CROSS REFERENCE TO RELATED APPLICATION

This application claims the benefit of Korean Patent Application No. 10-2010-0089006, filed on Sep. 10, 2010, entitled “Touch Screen and Method of Manufacturing the Same,” which is hereby incorporated by reference in its entirety into this application.

### BACKGROUND OF THE INVENTION

1. Technical Field

The present invention relates to a touch screen and a method of manufacturing the same.

2. Description of the Related Art

With the development of electronic engineering technologies and information technologies, a proportion in which electronic devices occupy daily life including a work environment has been steadily increasing. In particular, due to the development of electronic technologies, a touch screen may be widely used for portable devices, which are miniaturized and have become thinner.

The touch screen may be generally installed in a display device, and may sense a position in which a user touches a screen to perform a control of the electronic device including a screen control of a display based on information about the sensed position as input information, so that there are various advantages in that the touch screen may be simply operated to reduce misoperation, space saving may be achieved, and interoperability with information technology (IT) devices may be facilitated.

Meanwhile, the touch screen may be used in various schemes such as a resistive type, a capacitive type, an electro-magnetic type, a saw type, an infrared type, and the like. Of these, the resistive type and the capacitive type in consideration of both functional and economic aspects are widely used. Recently, research for the capacitive type in which touch sensation and durability are excellent and a multi-touch is performed have been conducted.

A touch screen in the prior art may include a transparent substrate, an indium tin oxide (ITO) electrode, and a window plate formed on an upper portion thereof for protecting other components.

In this instance, in order that a user can view an image from a display mounted below the touch screen, each of the transparent substrate, the ITO electrode, and the window plate may be made of a transparent material, and thereby an external light may enter an inside of the touch screen, and an internal light may be discharged to the outside of the touch screen.

However, the touch screen in the prior art may not effectively block light passing through the inside and outside of the touch screen, leading to deterioration in visibility of the touch screen. Specifically, when light enters from the outside of the touch screen, external light may reflect on respective interfaces of the touch screen, for example, an interface between the window plate and the transparent substrate, and the reflected light may be discharged to the outside of the touch screen, causing a problem in that an display image below the touch screen may become distorted. Also, when light that enters the touch screen and then is reflected on the touch screen is strong, such as when the touch screen is exposed to sunshine, it may be significantly difficult to recognize the display image itself

### SUMMARY OF THE INVENTION

The present invention has been made in an effort to provide a touch screen which may prevent a reflected light from an inside of a touch screen from being discharged to the outside of the touch screen to thereby improve visibility, and a method of manufacturing the same.

A touch screen according to a preferred embodiment of the present invention includes: a transparent substrate; a transparent electrode formed on the transparent substrate and adopted for sensing a change in a capacitance when a touch input is performed; an adhesive layer formed on the transparent substrate on which the transparent electrode is formed; a window plate bonded with the transparent substrate by the adhesive layer; and a circular polarization-coating layer coated on the window plate and adopted for transmitting light in one direction.

Here, the circular polarization-coating layer may include: a phase difference coating layer; and a linear polarization coating layer coated on one surface of the phase difference coating layer.

Also, the circular polarization-coating layer may further include a hard coating layer formed on the other surface of the phase difference coating layer.

Also, the phase difference coating layer may delay a phase by a ¼ wavelength of the linear polarization coating layer.

A method of manufacturing a touch screen according to a preferred embodiment of the present invention includes: forming a transparent electrode on a transparent substrate, the transparent electrode being adopted for sensing a change in a capacitance when a touch input is executed; bonding the transparent substrate with a window plate by interposing an adhesive layer between the transparent substrate on which the transparent electrode is formed and the window plate; and coating, on the window plate, a circular polarization coating layer for transmitting light in one direction.

In this instance, the coating the circular polarization coating layer may include: coating a phase difference coating layer on the window plate; and coating a linear polarization coating layer on the phase difference coating layer.

Also, the coating the circular polarization coating layer may include: forming a hard coating layer on the window plate; coating a phase difference coating layer on the hard coating layer; and coating a linear polarization coating layer on the phase difference coating layer.

Also, the phase difference coating layer may delay a phase by ¼ wavelength of the linear polarization coating layer.

### BRIEF DESCRIPTION OF THE DRAWINGS

FIGS. 1 and 2 are cross-sectional views showing a touch screen according to a preferred embodiment of the present invention;

FIGS. 3 and 4 are views for describing an operation scheme of the touch screen of FIGS. 1 and 2;

FIGS. 5 to 7 are process cross-sectional views for describing a method of manufacturing a touch screen according to a preferred embodiment of the present invention.

### DESCRIPTION OF THE PREFERRED EMBODIMENTS

Various features and advantages of the present invention will be more obvious from the following description with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

Objects, features, and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. Further, terms used in the specification, ‘first’, ‘second’, etc. can be used to describe various components, but the components are not to be construed as being limited to the terms. The terms are only used to differentiate one component from other components. Further, in describing the present invention, a detailed description of related known functions or configurations will be omitted so as not to obscure the subject of the present invention.

Meanwhile, in terminologies used in the present invention, “touch input” may be a term including both “touch” and “approach”. The “touch” may denote a case of being completely brought into close contact, and “approach” may denote a case of being closely approached even though not being brought into close contact.

Hereinafter, preferred embodiments of the present invention will be described in detail with reference to the accompanying drawings.

Structure of Touch Screen

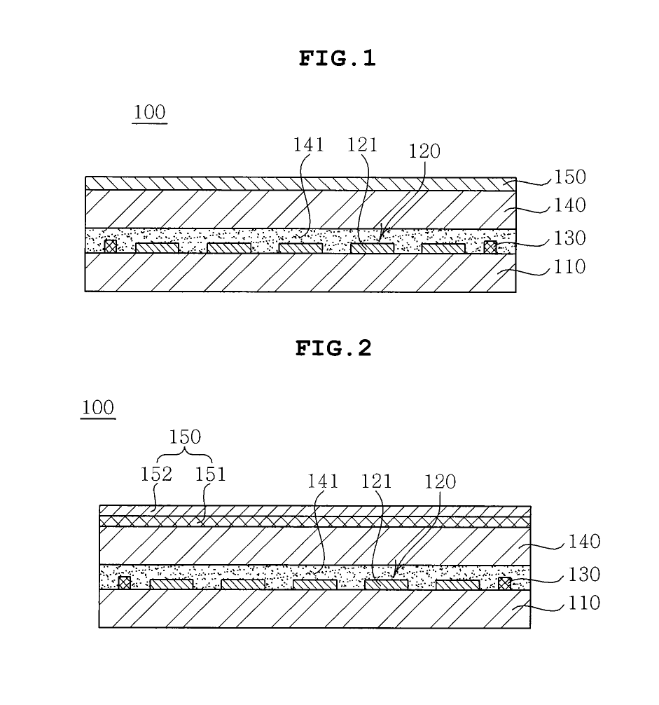

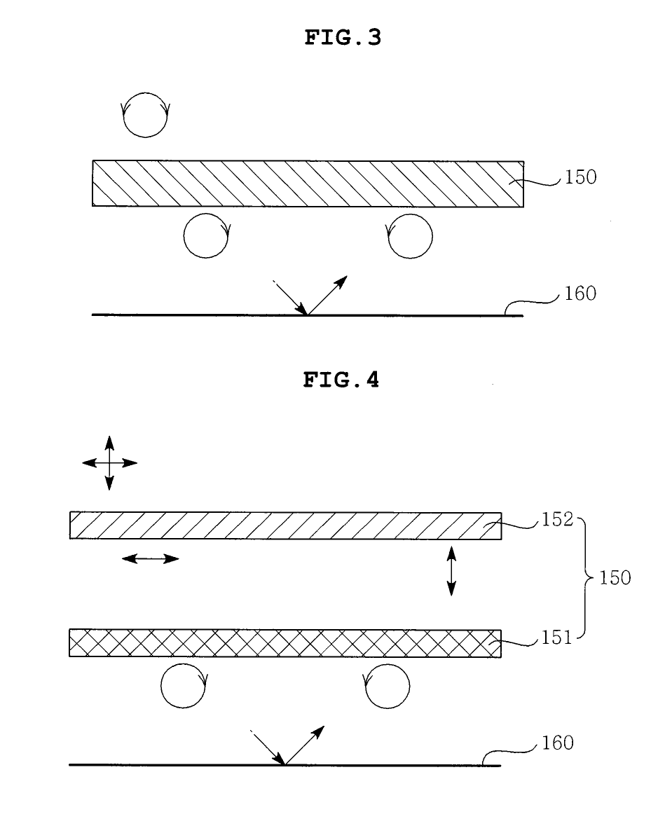

FIGS. 1 and 2 are cross-sectional views showing a touch screen according to a preferred embodiment of the present invention, and FIGS. 3 and 4 are views for describing an operation scheme of the touch screen of FIGS. 1 and 2. Hereinafter, a touch screen 100 according to the present preferred embodiment of the present invention will be described in detail.

As shown in FIGS. 1 and 2, the touch screen 100 includes a transparent substrate 110, a transparent electrode 120, an electrode 130, a window plate 140, and a circular polarization coating layer 150.

The transparent substrate 110 may be a member for providing a space formed by the transparent electrode 120, and may be a base of the touch screen 100.

Here, the transparent substrate 110 may be preferably made of a transparent material so that an image from a display (not shown) installed below the touch screen 100 is clearly transmitted to a user. As the transparent material, the transparent substrate 110 may made of polyethylene terephthalate (PET), polycarbonate (PC), polymethylmethacrylate (PMMA), polyethylene naphthalate (PEN), polyether sulfone (PES), or an annular cyclic olefin copolymer (COC). In addition, generally used glass or tempered glass may be utilized as the transparent material.

Also, a transparent electrode 120 may be formed on a surface of the transparent substrate 110, and may be preferably subjected to a high frequency treatment or a primer treatment in order to enhance an adhesion between the transparent substrate 110 and the transparent electrode 120.

The transparent electrode 120 may be formed on the surface of the transparent substrate 110, and may be a member for sensing a change in capacitance when a touch input is executed.

Here, the transparent electrode 120 may sense the change in capacitance from a touch input performed by a specific object such as a body of the user, a stylus pen, or the like, transmit the sensed touch input to a control unit (not shown), and recognize coordinates of a pressed position of the control unit (not shown) to thereby implement a desired operation. Specifically, when high frequency is distributed over an entire surface of the transparent electrode 120 due to receiving an applied voltage by the electrode 130, and then the touch input is performed by the body of the user, a predetermined change in the capacitance may occur in a case in which the transparent electrode 120 acts as the electrode, and the window plate 140, the adhesive layer 141 and/or the circular polarization coating layer 150 act as a dielectric. Here, the control unit (not shown) may sense a changed waveform to thereby recognize a position of the touch input, or recognize whether the touch input is performed.

Meanwhile, the transparent electrode 120 is preferably made of a conductive material to enable the change in the capacitance to be sensed. Also, since the transparent electrode 120 may be patterned over an entire surface of the transparent substrate 110, the transparent electrode 120 is preferably made of a transparent material. As the material of the transparent electrode 120, a conductive polymer obtained such that poly 3,4-ethylenedioxythiophene/polystyrenesulfonate (PEDOT/PSS), poly aniline, and the like are used alone or mixed, or a metal oxide such as indium tin oxide (ITO) may be used.

In addition, the transparent electrode 120 according to the present preferred embodiment may be formed as a single layer type, so that respective sensing units 121 may be self-capacitance so as to be electrically isolated; however, the present invention is not limited thereto. Thus, the respective sensing units 121 may be mutual capacitance obtained such that a plurality of sensing units 121 may be divided into an X-axis pattern and a Y-axis pattern to be connected to each other on the transparent substrate 110, and an insulating layer (not shown) may be interposed between bridge units (not shown) to prevent the sensing units 121 of the X-axis pattern and the Y-axis pattern from being mutually short-circuited. In addition, the respective sensing units 121 of the transparent electrode 120 may be formed to have various shapes such as a bar shape, a hexagon, an octagon, a triangle, a diamond shape.

The electrode 130 may be formed on an outer surface of the transparent substrate 110, and may be a member for applying a voltage to the transparent electrode 120.

Here, the electrode 130 may be preferably made of a material having superior electrical conductivity in order to enable the voltage to be supplied to the transparent electrode 120. For example, the electrode 130 may be made of a material composed by silver (Ag) paste or organic silver (Ag). Also, in order to reduce a bezel region, the electrode 130 may be made of a transparent material such as a conductive polymer or a metal oxide, similar to the transparent electrode 120.

The window plate 140 may be formed on a surface of the transparent substrate 110 on which the transparent electrode 120 is formed, and may be a member for protecting other components of the touch screen 100.

Here, since the window plate 140 may receive an input by the specific object such as the body of the user, the stylus pen, or the like, through the circular polarization coating layer 150, the window plate 140 may maintain an outline of an input unit of the touch screen 100. Accordingly, the window plate 140 may be preferably made of a transparent material having excellent durability to enable the touch screen 100 to be sufficiently protected from an external force, and to enable a display to be clearly viewed by the user, such as polyethylene terephthalate (PET) or a glass.

Meanwhile, in order to mutually fix the window plate 140 and the transparent substrate 110, the adhesive layer 141 may be formed between the window plate 140 and the transparent substrate 110. In this instance, the adhesive layer 141 may be entirely formed between the window plate 140 and the transparent substrate 110, and may be made of a material such as optical clear adhesive (OCA).

The circular polarization coating layer 150 may be coated on the window plate 140, and may be a member for selectively transmitting light in one direction.

Here, the circular polarization coating layer 150 may be formed of a single coating layer as shown in FIG. 1, or may be formed of two layers including a phase difference coating layer 151 coated on the window plate 140, and a linear polarization coating layer 152 coated on a surface of the phase difference coating layer 151, as shown in FIG. 2, or three layers further including a hard coating layer (not shown).

First, as shown in FIG. 3, in the case in which the circular polarization coating layer 150 is formed as the single coating layer, the circular polarization coating layer 150 may transmit, to an inside of the touch screen 100, only light in any one direction among light rotated in both directions, which enter the touch screen 100. Also, the transmitted light may be reflected on respective interfaces 160, for example, an interface between the circular polarization coating layer 150 and the window plate 140, an interface between the window plate 140 and the adhesive layer 141, an interface between the adhesive layer 141 and the transparent substrate 110, and the like, and may be rotated in an opposing direction by the reflection. Accordingly, when repeatedly advancing towards the outside of the touch screen 100, the reflected light may not be transmitted through the circular polarization coating layer 150. For example, when the circular polarization coating layer 150 transmits only light in a clockwise direction, that is, rotated clockwise, the clockwise light may be transmitted to the inside of the touch screen 100, and the transmitted clockwise light may be transformed to emit light counterclockwise, that is, rotated counterclockwise while being reflected on the interface 160. Here, the reflected counterclockwise light may not be transmitted through the circular polarization coating layer 150.

In addition, as shown in FIG. 4, in the case in which the circular polarization coating layer 150 is formed of the phase difference coating layer 151 and the linear polarization coating layer 152, light reflected from the inside of the touch screen 100 may be blocked. For example, light entering from the outside may have directivity in all directions, however only light corresponding to a transmission axis (for example, X-axis) of the linear polarization coating layer 152 may be transmitted when the light entering from the outside passes through the linear polarization coating layer 152. Also, the transmitted light may be transformed to circular polarized light that is rotated clockwise, due to a delay in the phase by a ¼ wavelength during which the transmitted light passes through the phase difference coating layer 151. Also, the circular polarized light that is rotated clockwise may be reflected on the respective interfaces 160 inside of the touch screen 100 to be transformed to circular polarized light that is rotated counterclockwise, that is, an advancing direction of light is changed. Here, the reflected circular polarized light that is rotated counterclockwise may be transformed to Y-axis linear polarized light that is orthogonal to X-axis linear polarized light at the time of entering, while repeatedly passing through the phase difference coating layer 151. Accordingly, since the Y-axis linear polarized light may not be transmitted through the linear polarization coating layer 152, internal reflected light may not be discharged to the outside.

In addition, the circular polarization coating layer 150 may further include a hard coating layer (not shown). Here, the hard coating layer (not shown) may be formed between the window plate 140 and the phase difference coating layer 151, and may protect the window plate 140 from external impact. Accordingly, the hard coating layer (not shown) may be preferably made of a resin having a large hardness such as acryl, a urethane resin, a siloxane resin, or the like.

Meanwhile, reflected light may not be discharged from the inside of the touch screen 100 to the outside of thereof by adding the circular polarization coating layer 150 to the touch screen 100, so that deterioration in display quality due to the reflected light may be prevented based on a view from the outside, thereby improving visibility.

Manufacturing Method of Touch Screen

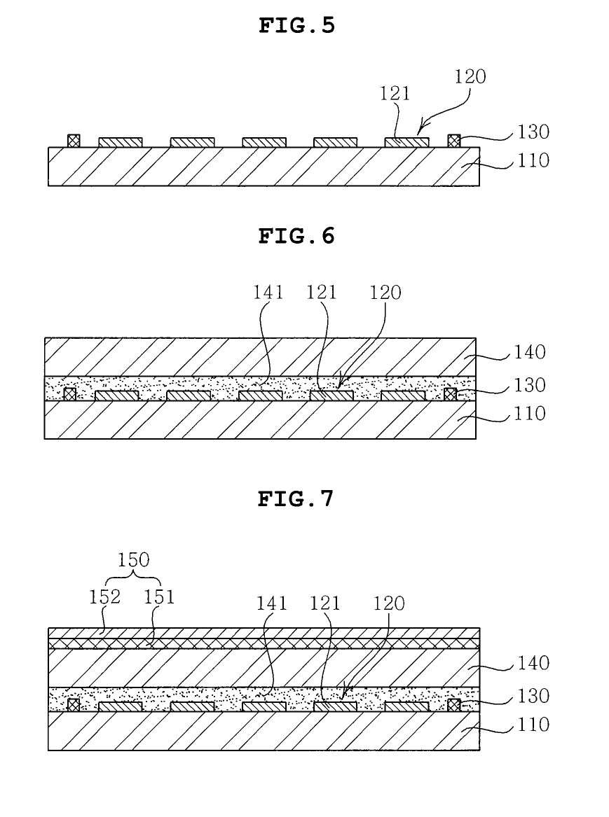

FIGS. 5 to 7 are process cross-sectional views for describing a method of manufacturing a touch screen according to a preferred embodiment of the present invention. Hereinafter, a method of manufacturing the touch screen 100 according to the present preferred embodiment will be described in detail. In the present preferred embodiment, the case in which the circular polarization coating layer 150 is formed of two layers of the phase difference coating layer 151 and the linear polarization coating layer 152 will be described; however, the present invention may also include the case in which the circular polarization coating layer 150 is formed of a single layer or three layers.

First, as illustrated in FIG. 5, the transparent electrode 120 and the electrode 130 may be formed on the transparent substrate 110.

In this instance, in the case of being made of a metal oxide, the transparent electrode 120 may be coated on the transparent substrate 110 through a deposition scheme, a developing scheme, an etching scheme, and the like, and in the case of being made of a conductive polymer, the transparent electrode 120 may be formed on the transparent substrate 110 through a silk screen printing scheme, an inkjet printing scheme, a gravure printing scheme, an offset printing scheme, or the like. For example, when using the silk screen printing scheme, an ink paste made of the conductive polymer may be put on a screen in a state in which the screen is tightly pulled to create a strong tension, and then the paste may be pushed out to an outer surface of the transparent substrate 110 through a mesh of the screen by moving a squeegee while pressing down the squeegee to thereby be scanned.

Also, the electrode 130 may be formed by printing a silver (Ag) paste on an outer surface of the transparent substrate 110.

Next, as shown in FIG. 6, the adhesive layer 141 may be interposed between the transparent substrate 110 on which the transparent electrode is formed and the window plate 140 to thereby bond the transparent substrate 110 and the window plate 140.

Next, as shown in FIG. 7, the circular polarization coating layer 150 may be coated on the window plate 140.

In this instance, in the case in which the circular polarization coating layer 150 is formed of a single coating layer, for example, a liquid crystal polymer such as a cholesteric liquid crystalline phase may be coated on the window plate 140 to thereby form the circular polarization coating layer 150. Also, in the case in which the circular polarization coating layer 150 includes the phase difference coating layer 151 and the linear polarization coating layer 152, the phase difference coating layer 151 may be first coated on the window plate 140, and the linear polarization coating layer 152 may be coated on the phase difference coating layer 151.

Meanwhile, in the case in which the circular polarization coating layer 150 further includes the hard coating layer (not shown), the hard coating layer (not shown) may be first formed on the window plate 140, and the phase difference coating layer 151 and the linear polarization coating layer 152 may be coated in this order on the hard coating layer (not shown).

By the above described method, the touch screen according to the preferred embodiment shown in FIG. 7 may be manufactured.

As described above, in the touch screen and the method of manufacturing the same according to the present invention, the reflected light from the inside of the touch screen may be effectively blocked by coating the circular polarization coating layer on the window plate, thereby improving visibility of the touch screen.

Although the preferred embodiments of the present invention have been disclosed for illustrative purposes, they are for specifically explaining the present invention and thus a touch screen and a method of manufacturing the same according to the present invention are not limited thereto, but those skilled in the art will appreciate that various modifications, additions and substitutions are possible, without departing from the scope and spirit of the invention as disclosed in the accompanying claims.

Accordingly, such modifications, additions and substitutions should also be understood to fall within the scope of the present invention.

What is claimed is:

1. A touch screen, comprising:
a transparent substrate;
a transparent electrode formed on the transparent substrate and adopted for sensing a change in capacitance when a touch input is executed;
an adhesive layer formed on the transparent substrate on which the transparent electrode is formed;
a window plate bonded with the transparent substrate by the adhesive layer; and
a circular polarization-coating layer coated on the window plate and adopted for transmitting light in one direction.

2. The touch screen as set forth in claim 1, wherein the circular polarization-coating layer includes:
a phase difference coating layer; and
a linear polarization coating layer coated on one surface of the phase difference coating layer.

3. The touch screen as set forth in claim 2, wherein the circular polarization-coating layer further includes a hard coating layer formed on the other surface of the phase difference coating layer.

4. The touch screen as set forth in claim 2, wherein the phase difference coating layer delays a phase by a ¼ wavelength of the linear polarization coating layer.

5. A method of manufacturing a touch screen, the method comprising:
forming a transparent electrode on a transparent substrate, the transparent electrode being adopted for sensing a change in a capacitance when a touch input is executed;
bonding the transparent substrate with a window plate by interposing an adhesive layer between the transparent substrate on which the transparent electrode is formed and the window plate; and
coating, on the window plate, a circular polarization coating layer transmitting light in one direction.

6. The method as set forth in claim 5, wherein the coating the circular polarization coating layer includes:
coating a phase difference coating layer on the window plate; and
coating a linear polarization coating layer on the phase difference coating layer.

7. The method as set forth in claim 5, wherein the coating the circular polarization coating layer includes:
forming a hard coating layer on the window plate;
coating a phase difference coating layer on the hard coating layer; and
coating a linear polarization coating layer on the phase difference coating layer.

8. The method as set forth in claim 6, wherein the phase difference coating layer delays a phase by a ¼ wavelength of the linear polarization coating layer.
